(19) United States
(12) Patent Application Publication
(10) Pub. No.: US 2013/0153833 A1
(43) Pub. Date: Jun. 20, 2013

(54) POLY(AMIC ACID AMIDEIMIDE) PHOSPHITE INTERMEDIATE TRANSFER MEMBERS

(71) Applicant: Jin Wu, Pittsford, NY (US)

(72) Inventor: Jin Wu, Pittsford, NY (US)

(73) Assignee: XEROX CORPORATION, Norwalk, CT (US)

(21) Appl. No.: 13/329,289

(22) Filed: Dec. 18, 2011

(51) Int. Cl. H01B 1/24; C08L 27/18; C08L 27/20; H01B 1/20; C08L 77/10; C08L 83/04

(52) U.S. Cl. 252/511; 525/436; 525/431; 525/180; 252/500

(57) ABSTRACT

An intermediate transfer member that includes a mixture of a poly(amic acid amideimide), a phosphite, an optional polymer, an optional conductive filler component and an optional release layer.

This disclosure is generally directed to an intermediate transfer member that includes a mixture of a poly(amic acid amideimide) polymer, a phosphite, an optional conductive component, an optional polymer, and an optional release layer.

### BACKGROUND

Intermediate transfer members, such as intermediate transfer belts selected for accepting and transferring developed images in xerographic systems, are known. For example, there are known intermediate transfer belts that contain polyphenylsulfones or thermosetting polyimides. The polyphenylsulfones have a tendency to degrade after a number of xerographic printing cycles, such as from about 20 to about 30 kiloprints, while polyimides can be costly, especially because such imides are usually subjected to curing by heating for extended time periods. Additionally, a number of known intermediate transfer members are not free of undesirable folding after usage thus causing the members to lose their integrity eventually requiring untimely replacement of such members.

Also known are intermediate transfer members that include materials with characteristics that cause these members to become brittle resulting in inadequate acceptance of the developed image, and subsequent partial transfer of developed xerographic images to a substrate like paper. Other disadvantages that may be associated with a number of intermediate transfer members relate to their inadequate mechanical strength, poor breakage characteristics, the unacceptable complete transfer of, for example, from about 80 to about 95 percent of xerographic developed images to a substrate like paper, and unstable and consistent resistivity causing degradation in the developed image being transferred from the member.

Intermediate transfer members that enable acceptable registration of the final color toner image in xerographic color systems using synchronous development of one or more component colors, and using one or more transfer stations are known. However, a disadvantage of using an intermediate transfer member, in color systems, is that a plurality of developed toner transfer operations is utilized thus sometimes causing charge exchange between the toner particles and the transfer member, which ultimately can result in less than complete toner transfer. This can result in low resolution images on the image receiving substrate like paper, and image deterioration. When the image is in color, the image can additionally suffer from color shifting and color deterioration.

There is a need for intermediate transfer members that substantially avoid or minimize the disadvantages of a number of known intermediate transfer members.

Further, there is a need for intermediate transfer member materials with minimal brittleness, and excellent break strengths.

Also, there is a need for intermediate transfer members that avoids or has minimal breakage properties for extended time periods, and that possesses a high modulus, robust mechanical properties inclusive of the avoidance of breaking tendencies when folded.

There is also a need for intermediate transfer members that can be economically and efficiently prepared.

Additionally, there is a need for intermediate transfer members that possess excellent transfer capabilities, and have minimal and acceptable brittleness characteristics.

Another need relates to intermediate transfer members that have excellent conductivity or resistivity, and that possess acceptable humidity insensitivity characteristics permitting developed images with acceptable resolution.

Also, there is a need for intermediate transfer member materials that have acceptable gloss characteristics for extended time periods.

Moreover, there is a need for intermediate transfer members with excellent wear and acceptable abrasion resistance.

These and other needs are achievable in embodiments with the intermediate transfer members, and components thereof disclosed herein.

### SUMMARY

Disclosed is an intermediate transfer member comprising a mixture of a poly(amic acid amideimide) and a phosphite.

Also disclosed is an intermediate transfer member comprising a layer comprising a mixture of a poly(amic acid-co-amideimide) copolymer, a phosphite, and a conductive filler component, and wherein the poly(amic acid-co-amideimide) copolymer is encompassed by the following formulas/structures

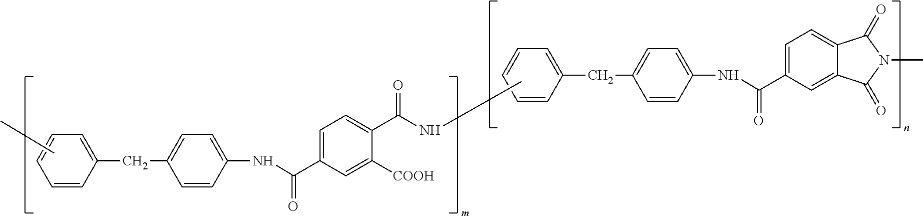

where m and n independently represent the number of repeating segments, where m is a number of from about 100 to about 1,000, and n is a number of from about 100 to about 1,000.

Further disclosed is an intermediate transfer member comprising a mixture of a phosphite, a poly(amic acid-co-amideimide) copolymer, and a conductive carbon black component, which member possesses a break strength of from about 120 to about 200 Mega Pascals, and resists breaking when folded, and wherein the poly(amic acid-co-amideimide) copolymer is encompassed by the following formulas/structures

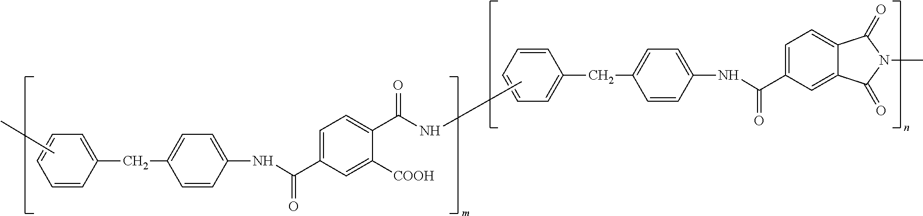

wherein m is a number of from about 200 to about 400, and n is a number of from about 200 to about 400, and wherein the phosphite is dibenzyl phosphite, dibutyl phosphite, tributyl phosphite, diethyl phosphite, diisobutyl phosphite, dimethyl phosphite, diphenyl phosphite, triethyl phosphite, trihexyl phosphite, triisodecyl phosphite, triisopropyl phosphite, trimethylpropane phosphite, trimethyl phosphite, trioctyl phosphite, trioleyl phosphite, triphenyl phosphite, tris(2,4-di-tert-butylphenyl) phosphite, tris(2-ethylhexyl) phosphite, tristearyl phosphite, tri-o-tolyl phosphite, or tri-p-tolyl phosphite.

### FIGURES

The following Figures are provided to further illustrate the intermediate transfer members disclosed herein.

FIG. 1 illustrates an exemplary embodiment of a one-layer intermediate transfer member of the present disclosure.

FIG. 2 illustrates an exemplary embodiment of a two-layer intermediate transfer member of the present disclosure.

FIG. 3 illustrates an exemplary embodiment of a three-layer intermediate transfer member of the present disclosure.

### EMBODIMENTS

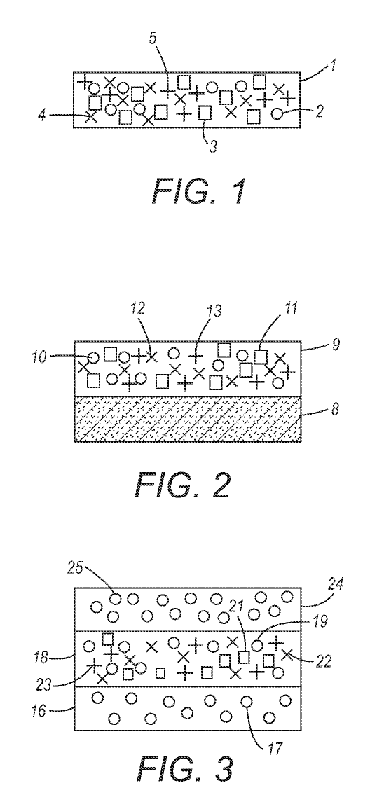

In FIG. 1 there is illustrated a one-layer intermediate transfer member comprising a polymer layer 1, comprising a poly(amic acid amideimide) or mixtures thereof 2, optional conductive components or fillers 3, phosphites 4, and optional siloxane polymers 5.

In FIG. 2 there is illustrated a two-layer intermediate transfer member comprising a supporting substrate 8, a layer 9 comprising a mixture of poly(amic acid amideimides) 10, fillers 11, phosphites 12, and siloxane polymers 13.

In FIG. 3 there is illustrated a three-layer intermediate transfer member comprising a supporting substrate 16, comprising fillers 17 dispersed therein, and thereover a layer 18 comprising a mixture of poly(amic acid amideimides) 19, fillers 21, phosphites 22, and siloxane polymers 23, and thereover a release layer 24 comprising release components 25.

There is provided herein an intermediate transfer member comprising a supporting substrate, and thereover in the configuration of a layer a mixture comprising a poly(amic acid amideimide) polymer, a phosphite, and a conductive component or filler like carbon black.

Also, disclosed herein is an intermediate transfer member that generally comprises a mixture of a phosphite and a poly(amic acid amideimide) copolymer, such as a poly(amic acid-co-amideimide), a phosphite, a suitable polymer like a polysiloxane polymer, and a conductive component or filler like carbon black, and which member exhibits improved folding properties compared to a number of conventional intermediate transfer members formed using polyimides, and at substantially reduced costs, such as about $32 per pound, for the poly(amic acid amideimide) polymer compared to about $200 per pound for known polyimides. The disclosed intermediate transfer members, where the mixture of components can be cured by heating, also possesses excellent developed image release characteristics, smooth high quality surfaces, excellent mechanical properties, inclusive of excellent non-breaking characteristics when the members are repeatedly folded, while permitting the rapid and complete transfer of from about 90 to about 98 percent, or from about 95 to about 100 percent transfer of xerographic developed images, together with a break strength of from about 100 to about 250 Mega Pascals, from about 105 to about 200 Mega Pascals, from about 120 to about 200 Mega Pascals, from about 110 to about 150 Mega Pascals, or about 127 Mega Pascals (MPa), and where resistance to folding of the disclosed intermediate transfer members continues for from about 100 to about 500, or from about 225 to about 400 repeated uses.

Also, the disclosed intermediate transfer members have a Young's modulus of, for example, from about 3,000 to about 8,000 Mega Pascals, from about 3,500 to about 6,000 Mega Pascals, or about 4,800 Mega Pascals, and which member possesses a break strength of from about 125 to about 180 Mega Pascals; a glass transition temperature (T_{g}) of from about 200 to about 400° C. or from about 250 to about 375° C.; and a CTE (coefficient of thermal expansion) of from about 10 to about 70 ppm/° K, or from about 20 to about 60 ppm/° K; and an excellent resistivity as measured with a known High Resistivity Meter of, for example, from about 10⁸ to about 10¹³ ohm/square, from about 10⁹ to about 10¹² ohm/square, or from about 10¹⁰ to about 10¹¹ ohm/square.

The intermediate transfer members of the present disclosure can be provided in any of a variety of configurations, such as a one-layer configuration, or in a multi-layer configuration including, for example, a supporting substrate and/or a release layer. The final intermediate transfer member may be in the form of an endless flexible belt, a web, a flexible drum or roller, a rigid roller or cylinder, a sheet, a drelt (a cross between a drum and a belt), seamless belt, and the like.

Poly(Amic Acid Amideimide) Polymers

Various suitable poly(amic acid amideimide) polymers can be selected for the intermediate transfer members disclosed herein, inclusive of poly(amic acid amideimide) copolymers, mixtures of two or more different poly(amic acid amideimide) polymers, and the like.

Examples of poly(amic acid amideimide) polymers selected for the disclosed intermediate transfer members that when heated will undergo cyclization to the imide form is represented by the following formulas/structures

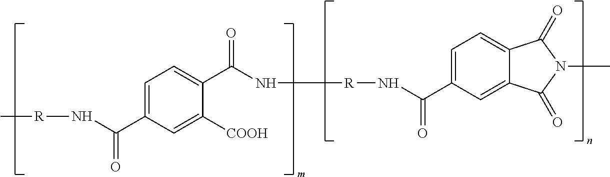

where m and n independently represent the respective number of repeating segments in the polymer chain like, for example, being a number of from about 20 to about 1,000, from about 75 to about 900, from about 275 to about 500, from about 100 to about 1,000, from about 100 to about 700, from about 150 to about 500, from about 325 to about 675, from about 200 to about 400, from about 200 to about 600, or fractions thereof, and where m and n can have the same values or dissimilar values from each other; each R is independently an aryl containing, for example, from about 6 to about 36 carbon atoms, from about 6 to about 24 carbon atoms, from about 6 to about 18 carbon atoms, from about 12 to about 24 carbon atoms, or from about 6 to about 12 carbon atoms.

Aryl R examples for the disclosed poly(amic acid amideimide) polymers are phenyl, naphthyl, anthryl, and those aryls as represented by the following formulas/structures and mixtures thereof

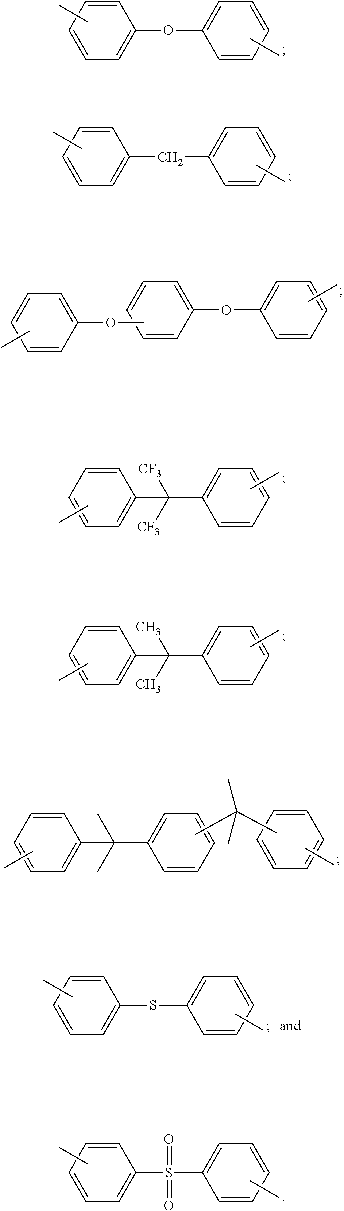

Specific examples of poly(amic acid amideimide) polymers selected for the disclosed intermediate transfer member mixtures include poly(amic acid-co-amideimide) copolymers as represented by the following formulas/structures

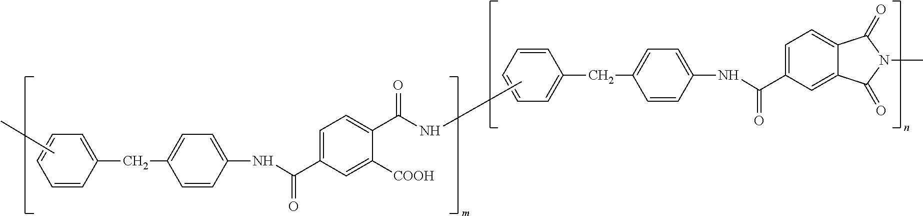

where m and n independently represent the respective number of repeating segments in the polymer chain, such as for example, being a number of from about 20 to about 1,000, from about 75 to about 900, from about 275 to about 500, from about 100 to about 1,000, from about 100 to about 700, from about 150 to about 500, from about 325 to about 675, from about 200 to about 400, from about 200 to about 600, or fractions thereof, and where m and n can have dissimilar values from each other.

Specific commercially available examples of the poly(amic acid amideimide) polymers present in the intermediate transfer members disclosed herein include TORLON® AI-10, AI-10LM, 4000T-LV, 4000T-MV, 4000T-HV or 4000TF, and the like, all available from Solvay Chemical Company.

The poly(amic acid amideimide) polymers, such as the poly(amic acid-co-amideimide) copolymers, available from Solvay Chemical Company, are believed to be a reactive poly(amic acid-co-amideimide) copolymer comprised of a trimellitic, aromatic amide, and aromatic imide moieties. For the poly(amic acid-co-amideimide) copolymers, available as TORLON® AI-10 from Solvay Chemical Company, approximately 50 percent of the copolymer is in the un-imidized or amic acid form, and then when heated to from about 90 to about 350° C., the copolymer undergoes cyclizations to the imide form.

Without being desired to be limited by theory, three processes are believed to occur during curing or heating in forming the disclosed poly(amic acid amideimide) polymers, it is believed, removal of the solvent, imidization, and chain extension or weight average molecular weight increase. For example, by heating the poly(amic acid amideimide)polymer at from about 93 to about 150° C., the imidization reaction occurs through cyclization of the ortho carboxylic acid with the amide to form the five-membered imide ring with the evolution of water. Continued heating at from about 150 to about 232° C. removes most, such as from about 95 to about 99 percent, of the solvent with some chain extension occurring. Also, peak temperatures of from about 249 to about 320° C. can be selected to remove any final traces of solvent and to permit selected molecular weights.

The number average molecular weight of the poly(amic acid amideimide) polymers selected for the disclosed intermediate transfer members in embodiments can be, for example, from about 2,000 to about 100,000, from about 5,000 to about 80,000, or from about 10,000 to about 50,000, and where the weight average molecular weight can be, for example, from about 4,000 to about 200,000, from about 10,000 to about 160,000, or from about 20,000 to about 100,000. The number average and weight molecular weights of the poly(amic acid amideimide) polymers are determined by known methods, such as GPC analysis.

The poly(amic acid amideimide) polymers as illustrated herein can be included in the intermediate transfer member mixture in various effective suitable amounts, such as in an amount of from about 70 to about 97 weight percent, from about 70 to about 95 weight percent, from about 75 to about 95 weight percent, or from about 80 to about 90 weight percent, based on the total solids.

Phosphites

The intermediate transfer member mixtures of the present disclosure include a phosphite or mixtures of phosphites that, in embodiments, function as a catalyst. Examples of suitable phosphites are aryl phosphites, such as diaryl phosphites, triaryl phosphites, and mixtures thereof; alkyl diarylphosphites, dialkyl arylphosphites, alkyl phosphites, and mixtures thereof, and yet more specifically, tributyl phosphite. Phosphite alkyls include those substituents with from about 1 to about 21, from about 1 to about 18, from 1 to about 12, from 1 to about 7, or from 1 to about 4 carbon atoms like methyl, ethyl, propyl, butyl, pentyl, heptyl, hexyl, octyl, nonyl, pentyl, isomers thereof, and substituted derivatives thereof. Aryl phosphite groups include those substituents with from about 6 to about 36, from 6 to about 30, from 6 to about 24, from 6 to about 18, or from 6 to about 12 carbon atoms such as phenyl, naphthyl, anthryl, and the like, mixtures thereof, and substituted derivatives thereof.

Specific phosphite examples that are included in the intermediate transfer member mixtures disclosed are dibenzyl phosphite, dibutyl phosphite, diethyl phosphite, diisobutyl phosphite, dimethyl phosphite, diphenyl phosphite, triethyl phosphite, trihexyl phosphite, triisodecyl phosphite, triisopropyl phosphite, trimethylpropane phosphite, trimethyl phosphite, trioctyl phosphite, trioleyl phosphite, triphenyl phosphite, tris(2,4-di-tert-butylphenyl) phosphite, tris(2-ethylhexyl) phosphite, tristearyl phosphite, tri-o-tolyl phosphite, tri-p-tolyl phosphite, and the like, and mixtures thereof.

The phosphites are contained in the disclosed intermediate transfer member mixtures in various effective amounts of, for example, from about 0.01 to about 15 weight percent, from about 0.1 to about 10 weight percent, from 0.1 to about 7 weight percent, from about 1 to about 5 weight percent, from about 1 to about 3 weight percent, and more specifically, about 2 weight percent based on the total solids contents.

Optional Polysiloxane Polymers

Examples of optional polysiloxane polymers that can be added to the poly(amic acid amideimide) and phosphite mixtures are polyether modified polydimethylsiloxanes, commercially available from BYK Chemical Company as BYK® 330 (about 51 weight percent in methoxypropylacetate); BYK® 344 (about 52.3 weight percent in xylene/isobutanol=80/20); BYK®-SILCLEAN 3710 and BYK®-SILCLEAN 3720 (about 25 weight percent in methoxypropanol); polyester modified polydimethylsiloxanes, commercially available from BYK Chemical Company as BYK® 310 (about 25 weight percent in xylene) and BYK® 370 (about 25 weight percent in xylene/alkylbenzenes/cyclohexanone/monophenylglycol=75/11/7/7); polyacrylate modified polydimethylsiloxanes, commercially available from BYK Chemical as BYK®-SILCLEAN 3700 (about 25 weight percent in methoxypropylacetate); BYK® 333; and polyester polyether modified polydimethylsiloxanes, commercially available from BYK Chemical as BYK® 375 (about 25 weight percent in di-propylene glycol monomethyl ether).

The polysiloxane polymer, or copolymers thereof can be present in the intermediate transfer mixture in various effective amounts, such as from about 0.01 to about 1 weight percent, from about 0.05 to about 1 weight percent, from about 0.05 to about 0.5 weight percent, and from about 0.1 to about 0.3 weight percent based on the weight of the polymer layer mixture.

Optional Fillers

Optionally, the intermediate transfer members illustrated herein may contain one or more fillers in the supporting substrate, when present, and in the poly(amic acid amideimide) polymer mixtures. For example, conductive fillers can be included to alter and adjust the conductivity of the disclosed intermediate transfer members. Where the intermediate transfer member is a one layer structure, the conductive filler can be included in the polymer containing mixture. However, where the intermediate transfer member is a multi-layer structure, the conductive filler can be included in one or more layers of the member, such as in the supporting substrate and/or the polymer mixture layer coated thereon.

Any suitable filler can be used that provides the desired results. For example, suitable fillers include carbon blacks, metal oxides, polyanilines, other known suitable fillers, and mixtures of fillers. When present, the filler can be included in the mixture in an amount of from about 1 to about 60 weight percent, from about 1 to about 30 weight percent, from about 3 to about 40 weight percent, from about 10 to about 30 percent, from about 4 to about 30 weight percent, or from about 5 to about 20 weight percent of the total weight of the solid components in the layer in which the filler is included.

Examples of carbon black fillers that can be selected for the intermediate transfer member include special black 4 (B.E.T. surface area=180 m²/g, DBP absorption=1.8 ml/g, primary particle diameter=25 nanometers), available from Evonik-Degussa; special black 5 (B.E.T. surface area=240 m²/g, DBP absorption=1.41 ml/g, primary particle diameter=20 nanometers); color black FW1 (B.E.T. surface area=320 m²/g, DBP absorption=2.89 ml/g, primary particle diameter=13 nanometers); color black FW2 (B.E.T. surface area=460 m²/g, DBP absorption=4.82 ml/g, primary particle diameter=13 nanometers), and color black FW200 (B.E.T. surface area=460 m²/g, DBP absorption=4.6 ml/g, primary particle diameter=13 nanometers), all available from Evonik-Degussa; VULCAN® carbon blacks, REGAL® carbon blacks, MONARCH® carbon blacks, and BLACK PEARLS® carbon blacks available from Cabot Corporation. Specific examples of conductive carbon blacks are BLACK PEARLS® 1000 (B.E.T. surface area=343 m²/g, DBP absorption=1.05 ml/g), BLACK PEARLS® 880 (B.E.T. surface area=240 m²/g, DBP absorption=1.06 ml/g), BLACK PEARLS® 800 (B.E.T. surface area=230 m²/g, DBP absorption=0.68 ml/g), BLACK PEARLS® L (B.E.T. surface area=138 m²/g, DBP absorption=0.61 ml/g), BLACK PEARLS® 570 (B.E.T. surface area=110 m²/g, DBP absorption=1.14 ml/g), BLACK PEARLS® 170 (B.E.T. surface area=35 m²/g, DBP absorption=1.22 ml/g), VULCAN® XC72 (B.E.T. surface area=254 m²/g, DBP absorption=1.76 ml/g), VULCAN® XC72R (fluffy form of VULCAN® XC72), VULCAN® XC605, VULCAN® XC305, REGAL® 660 (B.E.T. surface area=112 m²/g, DBP absorption=0.59 ml/g), REGAL® 400 (B.E.T. surface area=96 m²/g, DBP absorption=0.69 ml/g), REGAL® 330 (B.E.T. surface area=94 m²/g, DBP absorption=0.71 ml/g), MONARCH® 880 (B.E.T. surface area=220 m²/g, DBP absorption=1.05 ml/g, primary particle diameter=16 nanometers), and MONARCH® 1000 (B.E.T. surface area=343 m²/g, DBP absorption=1.05 ml/g, primary particle diameter=16 nanometers); and Channel carbon blacks available from Evonik-Degussa. Other known suitable carbon blacks not specifically disclosed herein may be selected as the filler or conductive component for the intermediate transfer member disclosed herein.

Examples of polyaniline fillers that can be selected for incorporation into the poly(amic acid amideimide) mixture are PANIPOL™ F, commercially available from Panipol Oy, Finland, and known lignosulfonic acid grafted polyanilines. These polyanilines usually have a relatively small particle size diameter of, for example, from about 0.5 to about 5 microns; from about 1.1 to about 2.3 microns, or from about 1.5 to about 1.9 microns.

Metal oxide fillers that can be selected for the disclosed intermediate transfer member poly(amic acid amideimide) containing mixture are, for example, tin oxide, antimony doped tin oxide, indium oxide, indium tin oxide, zinc oxide, titanium oxide, and the like.

Optional Polymers

In embodiments of the present disclosure, the intermediate transfer member can further include an additional optional polymer in the poly(amic acid amideimide) phosphite containing mixture.

Examples of suitable additional polymers include a polyimide, polyamideimide, a polycarbonate, a polyphenylene sulfide, a polyamide, a polysulfone, a polyetherimide, a polyester, a polyvinylidene fluoride, a polyethylene-co-polytetrafluoroethylene, a poly(amic acid amideimide) polymer, and the like, and mixtures thereof.

When an additional polymer is selected, it can be included in the poly(amic acid amideimide) mixture in any desirable and effective amounts, such as in an amount of from about 1 to about 75 weight percent, from about 2 to about 45 weight percent, or from about 3 to about 15 weight percent, based on the total weight of solids.

Supporting Substrate

If desired, a supporting substrate, in the configuration of a layer, can be included in the disclosed intermediate transfer members, such as below the poly(amic acid amideimide) phosphite mixture containing polymer layer. The supporting substrate can provide increased rigidity or strength to the intermediate transfer member. When a supporting substrate is present, a metal or glass substrate used in forming the intermediate member can be replaced by the supporting substrate material, or the supporting substrate can first be formed on a metal or glass substrate followed by forming the poly(amic acid amideimide) containing polymer layer and the added phosphite on the supporting substrate, and prior to removing the completed structure from the metal or glass substrate.

The disclosed poly(amic acid amideimide) and phosphite containing mixtures can be coated on any suitable supporting substrate material to form a dual layer intermediate transfer member. Exemplary supporting substrate materials include polyimides, polyamideimides, polyetherimides, and the like, and mixtures thereof.

More specifically, examples of the intermediate transfer member supporting substrates are polyimides inclusive of known low temperature, and rapidly cured polyimide polymers, such as VTEC™ PI 1388, 080-051, 851, 302, 203, 201, and PETI-5, all available from Richard Blaine International, Incorporated, Reading, Pa., polyamideimides, polyetherimides, thermosetting polyimides, and the like. The thermosetting polyimides can be cured at temperatures of from about 180° C. to about 260° C. over a short period of time, such as from about 10 to about 120 minutes, or from about 20 to about 60 minutes, and generally have a number average molecular weight of from about 5,000 to about 500,000, or from about 10,000 to about 100,000, and a weight average molecular weight of from about 50,000 to about 5,000,000, or from about 100,000 to about 1,000,000.

Also, for the supporting substrate there can be selected thermosetting polyimides that can be cured at temperatures of above 300° C., such as PYRE M.L.® RC-5019®, RC 5057®, RC-5069®, RC-5097®, RC-5053®, and RK-692®, all commercially available from Industrial Summit Technology Corporation, Parlin, N.J.; RP-46® and RP-50®, both commercially available from Unitech LLC, Hampton, Va.; DURIMIDE® 100, commercially available from FUJIFILM Electronic Materials U.S.A., Inc., North Kingstown, R.I.; and KAPTON® HN, VN and FN, all commercially available from E.I. DuPont, Wilmington, Del.

Examples of polyamideimides that can be selected as supporting substrates for the intermediate transfer members disclosed herein are VYLOMAX® HR-11NN (15 weight percent solution in N-methylpyrrolidone, T_{g}=300° C., and M_{w}=45,000), HR-12N2 (30 weight percent solution in N-methylpyrrolidone/xylene/methyl ethyl ketone=50/35/15 [weight percent], T_{g}=255° C., and M_{w}=8,000), HR-13NX (30 weight percent solution in N-methylpyrrolidone/xylene=67/33 [weight percent], T_{g}=280° C., and M_{w}=10,000), HR-15ET (25 weight percent solution in ethanol/toluene=50/50 [weight percent], T_{g}=260° C., and M_{w}=10,000), HR-16NN (14 weight percent solution in N-methylpyrrolidone, T_{g}=320° C., and M_{w}=100,000), all commercially available from Toyobo Company of Japan, and TORLON® AI-10 (T_{g}=272° C.), commercially available from Solvay Advanced Polymers, LLC, Alpharetta, Ga., where M_{w} represents the weight average molecular weight

Examples of specific polyetherimide supporting substrates that can be selected for the intermediate transfer members disclosed herein are ULTEM® 1000 (T_{g}=210° C.), 1010 (T_{g}=217° C.), 1100 (T_{g}=217° C.), 1285, 2100 (T_{g}=217° C.), 2200 (T_{g}=217° C.), 2210 (T_{g}=217° C.), 2212 (T_{g}=217° C.), 2300 (T_{g}=217° C.), 2310 (T_{g}=217° C.), 2312 (T_{g}=217° C.), 2313 (T_{g}=217° C.), 2400 (T_{g}=217° C.), 2410 (T_{g}=217° C.), 3451 (T_{g}=217° C.), 3452 (T_{g}=217° C.), 4000 (T_{g}=217° C.), 4001 (T_{g}=217° C.), 4002 (T_{g}=217° C.), 4211 (T_{g}=217° C.), 8015, 9011 (T_{g}=217° C.), 9075, and 9076, all commercially available from Sabic Innovative Plastics.

Once formed, the supporting substrate can have any desired and suitable thickness. For example, the supporting substrate can have a thickness of from about 10 to about 300 microns, from about 50 to about 150 microns, and from about 75 to about 125 microns.

Optional Release Layer

In embodiments, the disclosed intermediate transfer members may further include an optional outer release layer, usually present on top of the poly(amic acid amideimide) and phosphite mixture in the form of a layer, or present on the mixture of the poly(amic acid amideimide), the phosphite, the polysiloxane, and the filler. The release layer can be included, for example, to alter the surface characteristics of the disclosed intermediate transfer members to allow easier release of the toner developed xerographic from the members.

Exemplary materials or components that are suitable for use in a release layer include TEFLON®-like materials including fluorinated ethylene propylene copolymer (FEP), polytetrafluoroethylene (PTFE), polyfluoroalkoxy polytetrafluoroethylene (PFA TEFLON®), and other TEFLON-like materials; silicone materials, such as fluorosilicones and silicone rubbers, such as Silicone Rubber 552, available from Sampson Coatings, Richmond, Va., (polydimethyl siloxane/dibutyl tin diacetate, 0.45 gram DBTDA per 100 grams polydimethyl siloxane rubber mixture, with a molecular weight M_{w} of approximately 3,500); and fluoroelastomers, such as those sold as VITON®, such as copolymers and terpolymers of vinylidenefluoride, hexafluoropropylene, and tetrafluoroethylene, which are known commercially under various designations as VITON A®, VITON E®, VITON E60C®, VITON E45®, VITON E430®, VITON B910®, VITON GH®, VITON B50®, VITON E45®, and VITON GF®. The VITON® designation is a trademark of E.I. DuPont de Nemours, Inc. Two known fluoroelastomers are comprised of (1) a class of copolymers of vinylidenefluoride, hexafluoropropylene, and tetrafluoroethylene, known commercially as VITON A®; (2) a class of terpolymers of vinylidenefluoride, hexafluoropropylene, and tetrafluoroethylene, known commercially as VITON B®; and (3) a class of tetrapolymers of vinylidenefluoride, hexafluoropropylene, tetrafluoroethylene, and a cure site monomer, such as VITON GF®, having 35 mole percent of vinylidenefluoride, 34 mole percent of hexafluoropropylene, and 29 mole percent of tetrafluoroethylene with 2 percent cure site monomer. The cure site monomers can be those available from E.I. DuPont de Nemours, Inc. such as 4-bromoperfluorobutene-1,1,1-dihydro-4-bromoperfluorobutene-1,3-bromoperfluoropropene-1,1,1-dihydro-3-bromoperfluoropropene-1, or any other suitable known, commercially available cure site monomers.

The release layer may be deposited on the poly(amic acid amideimide) phosphite containing mixture by any known coating process. Known methods for forming the outer release layer include dipping, spraying, such as by multiple spray applications of very thin films, casting, flow-coating, web-coating, roll-coating, extrusion, molding, or the like.

Intermediate Transfer Member Formation

The poly(amic acid amideimide) and phosphite mixtures illustrated herein can be formulated into an intermediate transfer member by any suitable method. For example, with known milling processes, there can be prepared intermediate transfer members, or there can be prepared uniform dispersions of the intermediate transfer member mixture that is then coated on individual metal substrates, such as a stainless steel substrate or the like, using known draw bar coating methods. The resulting individual film or films can be dried at high temperatures, such as by heating at from about 100 to about 400° C., from about 160 to about 300° C., or other temperatures for a suitable period of time, such as from about 20 to about 180 minutes, or from about 40 to about 120 minutes, while remaining on the substrates. After drying and cooling to room temperature, about 23 to about 25° C., the films resulting can be removed from the substrates by known processes, such as by hand peeling, or such films can be self-releasing with no outside assistance. The resultant films can have a thickness of, for example, from about 15 to about 150 microns, from about 20 to about 100 microns, or from about 25 to about 75 microns.

As metal substrates selected for the deposition of the poly(amic acid amideimide) containing mixtures, there can be selected stainless steel, aluminum, nickel, copper, and their alloys, or other conventional materials. Other suitable substrates that can be used include glass plates, and the like.

Examples of solvents selected for formation of the poly(amic acid amideimide) and phosphite containing mixture, which solvents can be selected in an amount of from about 60 to about 95 weight percent, or from about 70 to about 90 weight percent of the total coating polymer mixture weight include alkylene halides, such as methylene chloride, tetrahydrofuran, toluene, monochlorobenzene, N-methyl-2-pyrrolidone, N,N-dimethylformamide, N,N-dimethylacetamide, methyl ethyl ketone, dimethylsulfoxide (DMSO), methyl isobutyl ketone, sulfolane, dimethyl acetate, formamide, acetone, ethyl acetate, cyclohexanone, acetanilide, mixtures thereof, and the like. Diluents can be mixed with the solvents of the poly(amic acid amideimide) copolymer solutions. Examples of diluents added to the solvents in amounts, for example, of from about 1 to about 25 weight percent, or from 1 to about 10 weight percent based on the weight of the solvent and the diluent are known diluents like aromatic hydrocarbons, ethyl acetate, acetone, cyclohexanone, and acetanilide.

The disclosed intermediate transfer members are, in embodiments, seamless, that is, with an absence of any seams or visible joints in the members. Moreover, the intermediate transfer members disclosed herein may be weldable. That is, opposite ends of the formed film can be welded together, such as by ultrasonic welding, to produce a seam.

The intermediate transfer members illustrated herein can be selected for a number of printing and copying systems, inclusive of xerographic printing systems. For example, the disclosed intermediate transfer members can be incorporated into a multi-imaging xerographic machine where each developed toner image to be transferred is formed on the imaging or photoconductive drum at an image forming station, and where each of these images is then developed at a developing station, and transferred to the intermediate transfer member. The images may be formed on a photoconductor and developed sequentially, and then transferred to the intermediate transfer member. In an alternative method, each image may be formed on the photoconductor or photoreceptor drum, developed, and then transferred in registration to the intermediate transfer member. In an embodiment, the multi-image system is a color copying system, wherein each color of an image being copied is formed on the photoreceptor drum, developed, and transferred to the intermediate transfer member.

After the toner latent image has been transferred from the photoreceptor drum to the intermediate transfer member, the intermediate transfer member may be contacted under heat and pressure with an image receiving substrate such as paper. The toner image on the intermediate transfer member is then transferred and fixed, in image configuration, to the substrate such as paper.

Specific embodiments will now be described in detail. These examples are intended to be illustrative, and are not limited to the materials, conditions, or process parameters set forth in these embodiments. All parts are percentages by weight of total solids unless otherwise indicated. The viscosity values were determined with a viscometer.

### COMPARATIVE EXAMPLE 1

A coating composition mixture comprising the poly(amic acid-co-amideimide) copolymer, TORLON® AI-10LM, obtained from Solvay Chemicals, where m is of a value of 300, n is of a value of 300, and R is C₆H₄—CH₂—C₆H₄ in the general formulas/structures illustrated herein, and special carbon black 4 (B.E.T. surface area=180 m²/g, DBP absorption=1.8 ml/g, primary particle diameter=25 nanometers), as obtained from DeGussa Chemicals, with a weight ratio of 83/17 in N-methylpyrrolidone (about 30 weight percent solids) was prepared with an Attritor.

The resulting dispersion, about 20 weight percent solids and with an about 2,400 cps (centipoise) viscosity, was flow coated on a stainless steel belt substrate of a thickness of 0.5 millimeter, followed by drying at 150° C. for 30 minutes, 200° C. for 30 minutes, 250° C. for 30 minutes and 290° C. for 30 minutes. There resulted after the obtained dried coating self-released and without any outside assistance from the stainless steel substrates, a seamless 100 micron thick intermediate transfer member as determined by visual observation and by use of a microscope, and where the weight ratio of the poly(amic acid-co-amideimide)/carbon black was 83/17 based on the above initial mixture feed amounts.

### EXAMPLE I

An intermediate transfer member was prepared by repeating the process of Comparative Example 1 except there was added to the poly(amic acid-co-amideimide) copolymer TORLON® AI-10LM and carbon black mixture, 2 weight percent of tributyl phosphite with the resulting dispersion, about 20 weight percent solids, and with an about 2,400 cps viscosity, being flow coated on a stainless steel belt substrate where the weight ratio of the poly(amic acid-co-amideimide)/carbon black/tributyl phosphite was 81/17/2 based on the above initial mixture feed amounts.

### EXAMPLE II

A number of intermediate transfer members are prepared by repeating the process of Example I except that the tributyl phosphite is replaced with the phosphites dibenzyl phosphite, dibutyl phosphite, diethyl phosphite, diisobutyl phosphite, dimethyl phosphite, diphenyl phosphite, triethyl phosphite, trihexyl phosphite, triisodecyl phosphite, triisopropyl phosphite, trimethylpropane phosphite, trimethyl phosphite, trioctyl phosphite, trioleyl phosphite, triphenyl phosphite, tris(2,4-di-tert-butylphenyl) phosphite, tris(2-ethylhexyl) phosphite, tristearyl phosphite, tri-o-tolyl phosphite, or tri-p-tolyl phosphite.

### Measurements

The above two intermediate transfer members (ITM) of Comparative Example 1, and Example I were measured for Young's modulus, for break strength by an Instron Tensile Tester, for CTE by Thermo-Mechanical Analyzer (TMA), for resistivity by a High Resistivity Meter, and the tendency to break when folded was measured by visual observation.

Samples of each intermediate transfer member (0.5 inch×12 inch) of Comparative Example 1 and Example I were placed at different times in Instron Tensile Tester measurement apparatus, and then the samples were elongated at a constant pull rate until breaking. During this time, there was recorded the resulting load versus the sample elongation. The Young's modulus was calculated by taking any point tangential to the initial linear portion of this curve and dividing the tensile stress by the corresponding strain. The tensile stress was calculated by the load divided by the average cross sectional area of each of the test samples. The break strength was recorded as the tensile stress when the sample broke or came apart.

The coefficient of thermal expansion (CTE) was measured using a Thermo-mechanical Analyzer (TMA). Two samples of the Comparative Example 1, Example I intermediate transfer members were cut using a razor blade and metal die to 4 millimeter wide pieces which were then individually mounted between a TMA clamp using a 8 millimeter spacing, and which samples were preloaded to a force of 0.05 Newtons. Data was analyzed from the 2^{nd} heat cycle. The CTE values were obtained as a linear fit using the above data between the temperature points of interest of from about −20 to about 50° C. region using the TMA software.

The measurement results are provided in Table 1.

TABLE 1

| | Young's | Break | | | Tendency To |
|---|---|---|---|---|---|
| | Modulus | Strength | Resistivity | CTE | Break When |
| ITM | (MPa) | (MPa) | (ohm/sq) | (ppm/°K) | Folded |
| Comparative | 4,000 | 91 | 10¹⁰ | 47.9 | Breakage |
| Example 1 | | | | | |
| Example I | 4,800 | 127 | 10¹⁰ | 37.9 | No Breakage |

The above prepared intermediate transfer members of Example I, and Example II may be deposited on a supporting substrate, such as a polyimide, and other suitable substrates as illustrated herein.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others. Unless specifically recited in a claim, steps or components of claims should not be implied or imported from the specification or any other claims as to any particular order, number, position, size, shape, angle, color, or material.

1. An intermediate transfer member consisting of a mixture of a conductive filler, a poly(amideimide) prepared from a (poly(amic acid amideimide) and a phosphite present in an amount of from about 0.01 to about 15 weight percent of total solids.

2. The intermediate transfer member in accordance with claim 1 wherein said poly(amic acid amideimide) possesses a number average molecular weight of from about 2,000 to about 100,000, and weight average molecular weight of from about 4,000 to about 200,000 as determined by GPC analysis.

3. The intermediate transfer member in accordance with claim 1 wherein said poly(amic acid amideimide) is represented by the following formulas/structures 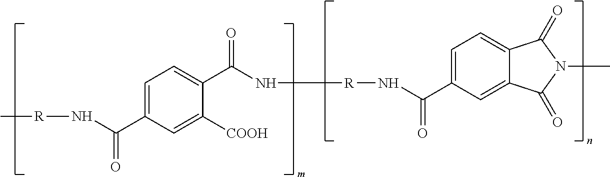
where m and n independently represent the number of repeating segments in the polymer chain, and each R is an aryl group.

4. The intermediate transfer member in accordance with claim 3 wherein n is from about 20 to about 1,000, m is from about 20 to about 1,000, and R is an aryl group containing from about 6 to about 36 carbon atoms.

5. The intermediate transfer member in accordance with claim 3 wherein m is from about 325 to about 675, and n is from about 325 to about 675.

6. The intermediate transfer member in accordance with claim 3 wherein R is selected from a group consisting of phenyl anthryl, naphthyl, those groups represented by the following formulas/structures 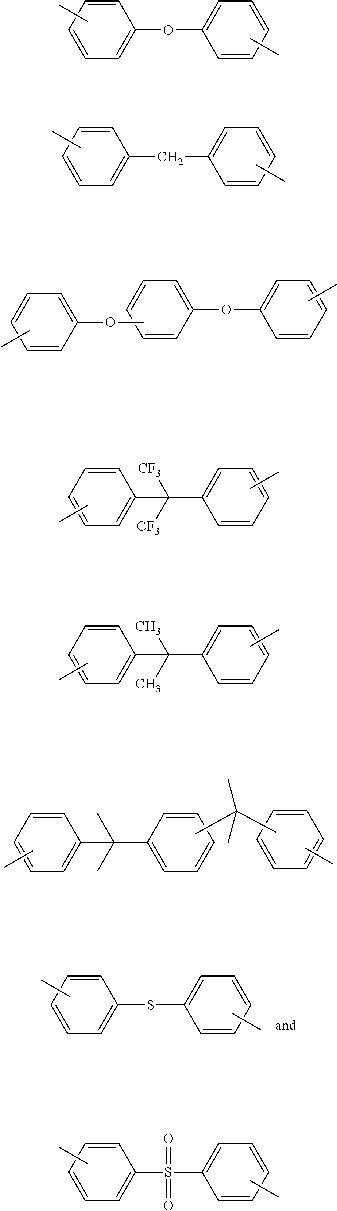
and mixtures thereof.

7. The intermediate transfer member in accordance with claim 1 wherein said poly(amic acid amideimide) polymer is a copolymer as represented by the following formulas/structures 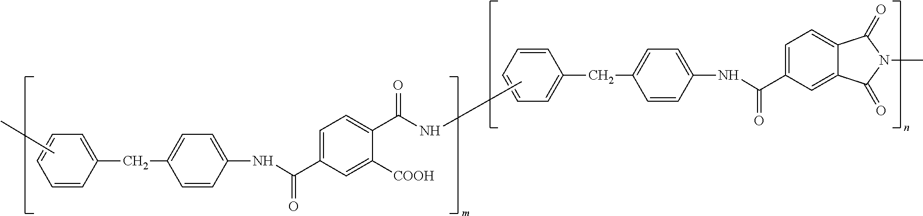
wherein m and n represent the number of repeating segments.

8. The intermediate transfer member in accordance with claim 7 where m is a number of from about 100 to about 1,000; and n is a number of from about 150 to about 500.

9. The intermediate transfer member in accordance with claim 19 wherein said phosphite present in an amount of about 2 weight percent is tributyl phosphite.

10. The intermediate transfer member in accordance with claim 1 wherein said phosphite is selected from the group consisting of alkyl phosphites, aryl phosphites, diaryl phosphites, triaryl phosphites, alkyl diaryl phosphites, dialkyl aryl phosphites, and mixtures thereof, each present in an amount of from about 0.1 to about 10 weight percent based on the total solids.

11. The intermediate transfer member in accordance with claim 1 wherein said phosphite is tributyl phosphite present in an amount of from about 1 to about 5 weight percent based on the total solids.

12. The intermediate transfer member in accordance with claim 1 wherein said phosphite is dibenzyl phosphite, dibutyl phosphite, diethyl phosphite, diisobutyl phosphite, dimethyl phosphite, diphenyl phosphite, triethyl phosphite, trihexyl phosphite, triisodecyl phosphite, triisopropyl phosphite, trimethylpropane phosphite, trimethyl phosphite, trioctyl phosphite, trioleyl phosphite, triphenyl phosphite, tris(2,4-di-tert-butylphenyl) phosphite, tris(2-ethylhexyl) phosphite, tristearyl phosphite, tri-o-tolyl phosphite, or tri-p-tolyl phosphite, each present in an amount of from about 1 to about 5 weight percent based on the total solids.

13. The intermediate transfer member in accordance with claim 1 wherein said poly(amic acid amideimide) is present in an amount of from about 70 to about 95 weight percent, said phosphite is present in an amount of from about 0.1 to about 10 weight percent, and wherein said conductive filter is carbon black present in an amount of from about 1 to about 30 weight percent of solids.

14. The intermediate transfer member in accordance with claim 1 with a break strength of from about 100 to about 250 Mega Pascals.

15. The intermediate transfer member in accordance with claim 16 wherein said polymer is present and is selected from the group consisting of a fluoridated ethylene propylene copolymer, a polytetrafluoroethylene, a polyfluoroalkoxy polytetrafluoroethylene, a fluorosilicone, a terpolymer of vinylidene fluoride, hexafluoropropylene, and tetrafluoroethylene and wherein said phosphite is an alkyl phosphite.

16. An intermediate transfer member consisting of a photoconductor and said member, wherein a xerographic developed toner image is transferred from said photoconductor to said intermediate transfer member and which member consists of a layer of a mixture of a poly(amideimide) prepared from a poly(amic acid-co-amideimide) copolymer, a phosphite, and a conductive filter component, and wherein the poly(amic acid-co-amideimide) copolymer is encompassed by the following formulas/structures 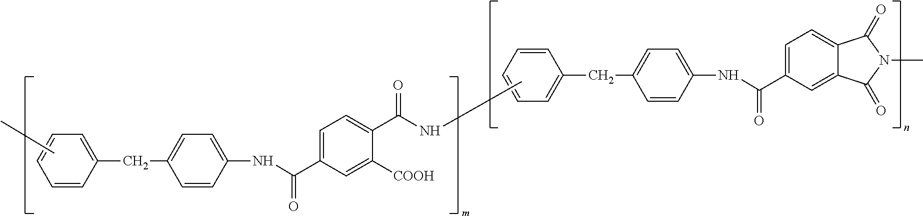
where m and n independently represent the number of repeating segments, where m is a number of from about 100 to about 1,000, and n is a number of from about 100 to about 1,000 and wherein said phosphite is selected from the group consisting of alkyl phosphites, aryl phosphites, diaryl phosphites, triaryl phosphites, alkyl diaryl phosphites, and dialkyl aryl phosphites, each present in an amount of from about 0.1 to about 10 weight percent based on the total solids and an optional polymer.

17. The intermediate transfer member in accordance with claim 16 wherein m is a number of from about 275 to about 500, and n is a number of from about 275 to about 500, wherein the poly(amic acid-co-amideimide) copolymer has a number average molecular weight of from about 10,000 to about 50,000, and a weight average molecular of from about 20,000 to about 108,000 as determined by GPC analysis and a break strength of from 110 to about 150 Mega Pascals.

18. The intermediate transfer member in accordance with claim 16 wherein said polymer is present and is selected from the group consisting of a fluorinated ethylene propylene copolymer, a polytetrafluoroethylene, a polyfluoroalkoxy polytetrafluoroethylene, a fluorosilicone, a terpolymer of vinylidene fluoride, hexafluoropropylene, tetrafluoroethylene, and mixtures thereof.

19. An intermediate transfer member consisting of a photoconductor and said member, wherein a xerographic developed toner image is transferred from said photoconductor to said intermediate transfer member and which member consists of a mixture of a phosphite, a poly(amideimide) prepared from a poly(amic acid-co-amideimide) copolymer, and a conductive carbon black component, which member possesses a break strength of from about 120 to about 200 Mega Pascals, and resists breaking when folded, and wherein the poly(amic acid-co-amideimide) copolymer is encompassed by the following formulas/structures 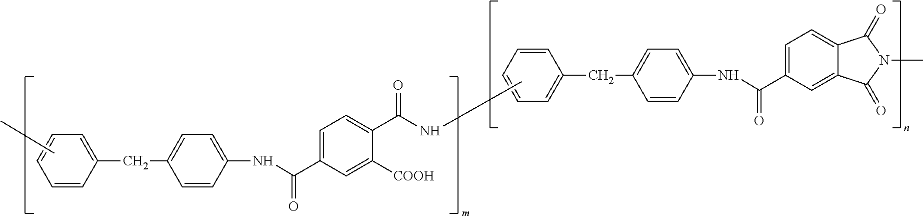
wherein m is a number of from about 200 to about 400, and n is a number of from about 200 to about 400, and wherein said phosphite present in an amount from about 0.01 to about 15 weight percent of total solids is dibenzyl phosphite, dibutyl phosphite, tributyl phosphite, diethyl phosphite, diisobutyl phosphite, dimethyl phosphite, diphenyl phosphate, triethyl phosphite, trihexyl phosphite, triisodecyl phosphite, triisopropyl phosphite, trimethylpropane phosphite, trimethyl phosphite, trioctyl phosphite, trioleyl phosphite, triphenyl phosphite, tris(2,4-di-tert-butylphenyl) phosphite, tris(2-ethylhexyl) phosphite, tristearyl phosphite, tri-o-tolyl phosphite, or tri-p-tolyl phosphite.

20. The intermediate transfer member in accordance with claim 19 where said resistance to folding continues for from about 100 to about 500 repeated uses, and which member possesses a break strength of from about 125 to about 180 Mega Pascals and wherein said phosphite is tributyl phosphite present in an amount of from about 2 to about 5 weight percent based on total solids.
